(19) United States
(12) Patent Application Publication
(10) Pub. No.: US 2017/0370221 A1
(43) Pub. Date: Dec. 28, 2017

(54) METHODS FOR REPAIRING A DAMAGED COMPONENT OF AN ENGINE

(71) Applicant: General Electric Company, Schenectady, NY (US)

(72) Inventor: Ronald Scott Bunker, West Chester, OH (US)

(21) Appl. No.: 15/191,905

(22) Filed: Jun. 24, 2016

(51) Int. Cl. F01D 5/00; F01D 9/02; B33Y 40/00; B33Y 70/00; B23P 6/04; C23C 24/10; F01D 5/18; B33Y 10/00; F23R 3/00; B23P 6/00; B33Y 50/00

(52) U.S. Cl. CPC F01D 5/005; F23R 3/002; F01D 9/02; B33Y 40/00; B33Y 70/00; B23P 6/007; B23P 6/045; C23C 24/106; F01D 5/186; B33Y 10/00; B33Y 50/00; F05D 2230/10; F05D 2230/30; F05D 2230/80; F05D 2240/35; F05D 2260/202; F05D 2300/175

(57) ABSTRACT

Methods for repairing a component having a damaged region are provided. The method can include removing the damaged portion from the component to form an intermediate component, wherein the damaged portion has an original geometry; and applying using additive manufacturing a repaired portion onto the intermediate component to form a repaired component. The repaired portion can have a repaired geometry that includes at least one film hole absent in the original geometry, with the film holes being fluidly connected to a cooling supply of the repaired component.

### FIELD OF THE INVENTION

The present invention generally relates to methods for repairing an airfoil of an engine and, more particularly, to methods of rebuilding the component to include film holes not present in the original component.

### BACKGROUND OF THE INVENTION

In order to increase the efficiency and the performance of gas turbine engines so as to provide increased thrust-to-weight ratios, lower emissions and improved specific fuel consumption, turbine engines are tasked to operate at higher temperatures. The components operating within the hot gas sections of the gas turbine engines are subjected to oxidation and thermo-mechanical fatigue amongst other life reducing causes, resulting in repair needs and issues. Typically, components that are damaged beyond repair are replaced with a new component, thereby increasing down-time and costs.

Various components within the gas turbine engine, including certain stator vanes (e.g., turbine nozzles) and rotor blades (e.g., turbine blades), are film cooled across certain areas of the component. Even still, areas of the component can be damaged over time forming distressed areas on the component over time during use. However, the replacement component, in operation, would be subjected to the same fate after its use in the engine. Thus, additional repair and replacement would be required.

Accordingly, it is desirable to provide improved repair methods for turbine components that enable improved cycle times and reduced costs without sacrificing component performance or durability.

### BRIEF DESCRIPTION OF THE INVENTION

Objects and advantages of the invention will be set forth in part in the following description, or may be obvious from the description, or may be learned through practice of the invention.

Methods are generally provided for repairing a component having a damaged region. In one embodiment, the method includes removing the damaged portion from the component to form an intermediate component, wherein the damaged portion has an original geometry; and applying using additive manufacturing a repaired portion onto the intermediate component to form a repaired component. Generally, the repaired portion has a repaired geometry that includes at least one film hole absent in the original geometry, with the film holes being fluidly connected to a cooling supply of the repaired component.

Other features and aspects of the present invention are discussed in greater detail below.

### BRIEF DESCRIPTION OF THE DRAWINGS

The invention may be best understood by reference to the following description taken in conjunction with the accompanying drawing figures in which:

FIG. 1 is a perspective view of an exemplary component having a damaged region, such as a turbine blade of a gas turbine engine;

FIG. 2 is a perspective view of an intermediate component formed by removing the damaged region from the component of FIG. 1;

FIG. 3 is a perspective view of the repaired component after applying, using additive manufacturing, a repaired portion onto the intermediate component of FIG. 2; and

FIG. 4 is a diagram showing an exemplary method of repairing a damaged portion of a component.

Repeat use of reference characters in the present specification and drawings is intended to represent the same or analogous features or elements of the present invention.

### DETAILED DESCRIPTION OF THE INVENTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Methods are generally provided for repairing a component having a damaged region, particularly for a component of an engine (e.g., a gas turbine engine). In one embodiment, a damaged portion of the component is first removed to form an intermediate component, and then repaired using additive manufacturing to form a repaired portion on the intermediate component. The repaired portion has a geometry that includes at least one film hole absent in the original damaged geometry (previously removed), with the film holes being fluidly connected to a cooling supply of the repaired component. Generally, the repaired portion is formed via additive manufacturing to include the film hole(s) without any additional drilling or other hole forming operation due to the layer by layer formation additive manufacturing process. As such, the component can be repaired to include additional film holes not present in the original component in order to serve as a corrective action to relieve the causation of the original damaged region.

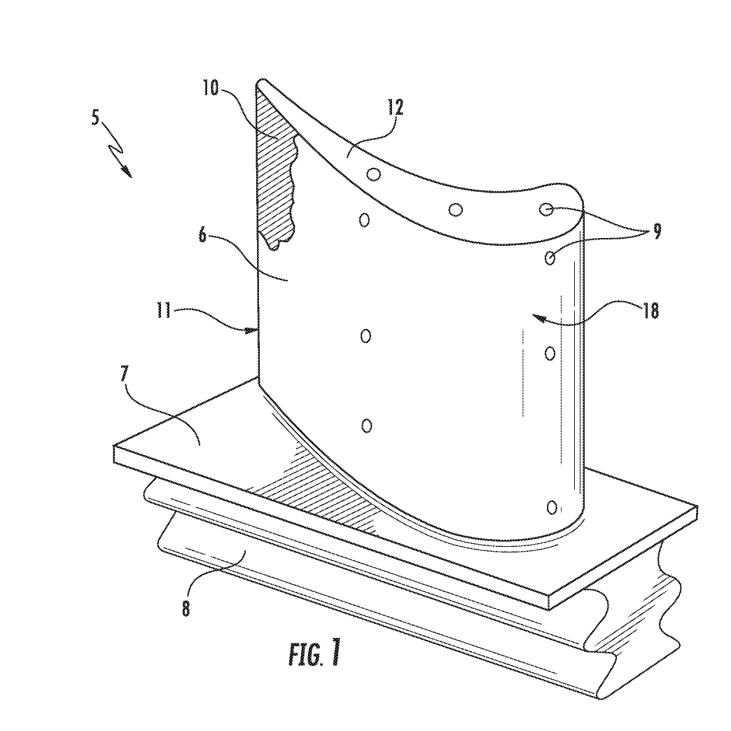

Referring to the drawings, FIG. 1 depicts an exemplary component 5 of a gas turbine engine, illustrated as a gas turbine blade. The turbine blade 5 includes an airfoil 6, a laterally extending platform 7, and an attachment 8 in the form of a dovetail to attach the gas turbine blade 5 to a turbine disk. In some components, a number of cooling channels extend through the interior of the airfoil 6, ending in openings 9 in the surface of the airfoil 6. The openings 9 may be, in particular embodiments, film holes.

The component 5 of FIG. 1 includes a damaged region 10. The damaged region 10 is shown on the upper portion of the trailing edge 11 to the tip 12 of the blade 5 and along the pressure and suction sides of the blade 5. Although shown on the upper portion of the trailing edge 11 of the blade 5 as an example of the location, the damaged portion 10 can be on any location of the component 5. In one embodiment, the damaged portion 10 corresponds to a distressed section of the blade 6, such as a burned portion that has degraded over time during use, an abraded and/or dented portion that has lost its original shape, a missing portion that lost material on its surface, etc.

Generally, the damaged portion 10 has an original geometry that was present in its pre-damaged state, which may or may not be the same as the geometry of its damaged state (e.g., a damaged geometry). In certain embodiments, the original geometry is substantially free from cooling holes (e.g., film holes) within the damaged portion 10 (as shown), although other embodiments may include film holes within the damaged geometry.

In one embodiment, the airfoil 6 of the turbine blade 5 of FIG. 1 are located in the turbine section of the engine and are subjected to the hot combustion gases from the engine's combustor. In addition to forced air cooling techniques (e.g., via film holes 9), the surfaces of these components are protected by a coating system 18 on the surface of the blade 5.

The airfoil 6 of the turbine blade 5 of FIG. 1 can be formed of a material that can be formed to the desired shape and generally withstand the necessary operating loads at the intended operating temperatures of the area of the gas turbine in which the segment will be installed. Examples of such materials include metal alloys that include, but are not limited to, titanium-, aluminum-, cobalt-, nickel-, and steel-based alloys. In one particular embodiment, the airfoil 6 of FIG. 1 is formed from a superalloy metal material, such as a nickel-based superalloy, a cobalt-based superalloy, or an iron-based superalloy. In typical embodiments, the superalloy component has a 2-phase structure of fine γ-(M) (face-center cubic) and β-(M)Al (body-center cubic). The β-(M)Al phase is the aluminum (Al) reservoir. Aluminum near the surface may be depleted during service by diffusion to the TBC interface forming α-Al₂O₃ thermally grown oxide on the surface of the diffusion coated substrate.

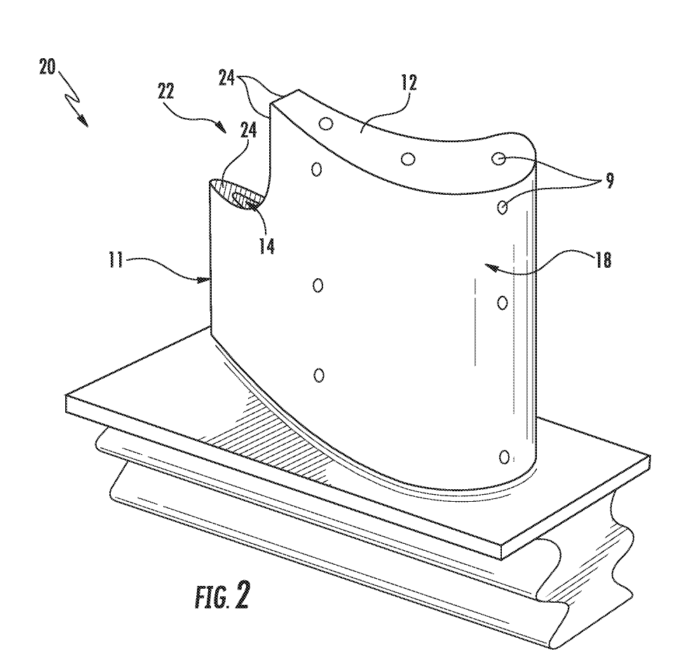

Referring to FIG. 2, an intermediate component 20 is shown based on the blade 5 of FIG. 1 with the damaged portion 10 removed to define a cavity 22. The cavity 22 is at least as big as the damaged portion 10 on the component 5. In certain embodiments, the removed portion cavity 22 may be slightly larger in volume of the component 5 than the damaged portion 10 (e.g., greater than about 105%, or greater than about 110% of the volume of the damaged portion 10) such that the removed portion captures all of the damaged material.

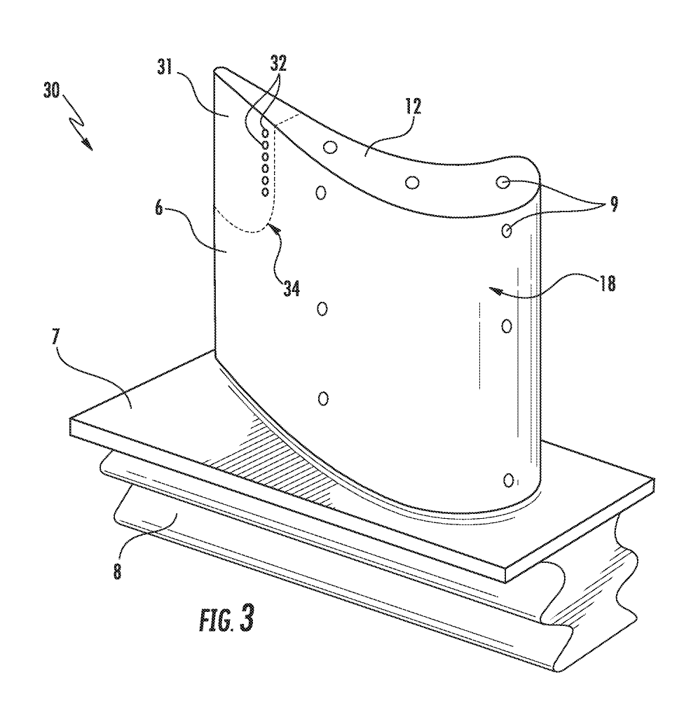

As such, it can be ensured that the entire damaged portion 10 can be removed to form the intermediate component 20. For example, other material can be removed in order to result in the intermediate component 20 having known dimensions, particularly having known dimensions defining the cavity 22. For example, the intermediate component 20 can have a predetermined height from which the repaired component 30 of FIG. 3 can subsequently be rebuilt. The predetermined height may be determined based on considerations such as the extent of the damaged portion 10 and/or the structure of the interior cooling passages 14.

In one embodiment, the damaged portion 10 of the component 5 is cleaned prior to removing the damaged portion 10 in order to first remove any coatings or other external layers present. For example, thermal barrier coatings (TBC) 18 may be removed from the damaged portion 10.

In particular embodiments, removal of the damaged portion 10 can be achieved by machining the component 5 around the damaged portion 10 to result in the intermediate component 20 of FIG. 2. Then, the surfaces 24 defining the cavity 22 can be prepared for subsequent application of a repaired portion 32, as shown in FIG. 3. That is, for example, the surfaces 24 of the cavity may undergo grit blasting, water blasting, and further cleaning to remove debris and oxides from the cavity surfaces 24.

Referring to FIG. 3, a repaired component 30 is shown formed from the intermediate component 20 of FIG. 2 with a repaired portion 31 applied within the space where the cavity was located. The repaired portion 31 is bonded, in this example, to the surface 24 of the cavity at the braze 34, although it is not visibly detectable in many embodiments.

In order to form the repaired component 30, the repaired portion 31 is formed via an additive manufacturing process, either directly onto the intermediate component 20 (e.g., applied layer by layer directly onto the surfaces 24 of the cavity 22) or formed separately from the intermediate component 20 and subsequently bonded onto the surfaces 24 of the cavity 22. In either method, the use of additive manufacturing allows for the repaired portion 31 to have a repaired geometry that is different than the original geometry of the component 5 and/or of the damaged geometry of the damaged portion 10. For example, in the particular embodiment shown in FIG. 3, the repaired geometry includes at least one film hole 32 absent in the original and/or damaged geometry. The film holes 32 are fluidly connected to an internal cavity 14 such that a cooling supply can be directed through the film holes 32 of the repaired component 30. For example, the repaired geometry (e.g., the second geometry) can include a plurality of film holes 32 absent in the first geometry. In one embodiment, the repaired geometry is substantially identical to the original geometry but for the at least one film hole of the repaired geometry that is absent in the original geometry. Thus, the repaired component 30 can be rebuilt so as to be modified, improved, or otherwise altered from the original design in response to corrective action to relieve the cause that formed the damaged region (e.g., exposure to excess heat loading). For example, the film holes 32 of the repaired geometry can mitigate heat directed at the component 5 in the repaired portion 31, so as to inhibit the cause of the damaged portion 10.

The repaired portion 31 may be formed from a material that has a substantially identical composition than the material of the component 5 (e.g., the same superalloy). Alternatively, the repaired portion 31 may be formed from a material that is different in composition than the material of the component 5 (e.g., different superalloy). However, when using different materials, the coefficient of thermal expansion (CTE) should be tailored to be close to each other to keep the material from spalling during use in the operating conditions of a turbine engine.

In one embodiment, the repaired portion 30 is formed via a direct metal laser fusion process, which is a laser-based rapid prototyping and tooling process utilizing precision melting and solidification of powdered metal into successive layers of larger structures, each layer corresponding to a cross-sectional layer of the 3D component. As known in the art, the direct metal laser fusion system relies upon a design model that may be defined in any suitable manner (e.g., designed with computer aided design (CAD) software). The model may include 3D numeric coordinates of the entire configuration of the component including both external and internal surfaces of an airfoil, platform and dovetail, as well as any internal channels and openings. In one exemplary embodiment, the model may include a number of successive 2D cross-sectional slices that together form the 3D component. Particularly, such a model includes the successive 2D cross-sectional slices corresponding to the turbine component from the machined height. For example, the intermediate component 20 can be imaged to create a digital representation of the intermediate component 20 after removal of the damaged portion 10, and a CAD model can be utilized to form the repaired portion 32 thereon.

Any suitable laser and laser parameters may be used, including considerations with respect to power, laser beam spot size, and scanning velocity. The build material may be formed by any suitable powder, including powdered metals, such as a stainless steel powder, and alloys and super alloy materials, such as nickel-based or cobalt superalloys. In one exemplary embodiment, the build material is a high temperature nickel base super alloy. The powder build material may be selected for enhanced strength, durability, and useful life, particularly at high temperatures. Each successive layer may be, for example, between 10 μm and 200 μm, although the thickness may be selected based on any number of parameters.

As noted above, the repaired component 30 includes internal cooling passages that deliver a cooling flow to the film holes 32. The cooling passages may be relatively complex and intricate for tailoring the use of the limited pressurized cooling air and maximizing the cooling effectiveness thereof and the overall engine efficiency. However, the successive, additive nature of the laser fusion process enables the construction of these passages.

Although the direct metal laser fusion process is described above, other rapid prototyping or additive layer manufacturing processes may be used to apply and form the repaired portion 32, including micro-pen deposition in which liquid media is dispensed with precision at the pen tip and then cured; selective laser sintering in which a laser is used to sinter a powder media in precisely controlled locations; laser wire deposition in which a wire feedstock is melted by a laser and then deposited and solidified in precise locations to build the product; electron beam melting; laser engineered net shaping; direct metal laser sintering; and direct metal deposition. In general, additive repair techniques provide flexibility in free-form fabrication and repair without geometric constraints, fast material processing time, and innovative joining techniques.

Other post processing may be performed on the repaired component 30, such as stress relief heat treatments, peening, polishing, hot isostatic pressing (HIP), or coatings.

Although described above and in FIGS. 1-3 with respect to the turbine blade 5, the methods of repair can be utilized with any component of the gas turbine engine, such as turbine nozzles (e.g., airfoils of a turbine nozzle or nozzle segment), compressor blades, compressor vanes, combustion liners, turbine shrouds, fan blades, etc.

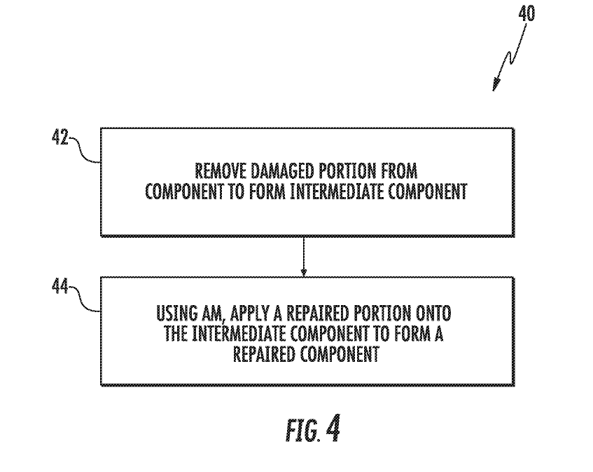

FIG. 4 shows a diagram of an exemplary method 40 of repairing a damaged portion of a component. At 42, a damaged portion is removed from the component to form an intermediate component. The damaged portion has a first geometry. At 44, using additive manufacturing (AM), a repaired portion is applied onto the intermediate component to form a repaired component having a second geometry that includes at least one film hole absent in the first geometry. For example, the film holes are fluidly connected to a cooling supply of the repaired component.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed is:

1. A method of repairing a component having a damaged region, the method comprising:
removing the damaged portion from the component to form an intermediate component, wherein the damaged portion has an original geometry; and
applying using additive manufacturing a repaired portion onto the intermediate component to form a repaired component, wherein the repaired portion has a repaired geometry that includes at least one film hole absent in the original geometry, and wherein the film holes are fluidly connected to a cooling supply of the repaired component.

2. The method of claim 1, wherein the repaired geometry includes a plurality of film holes absent in the original geometry.

3. The method of claim 1, wherein the repaired geometry is substantially identical to the original geometry but for the at least one film hole of the repaired geometry that is absent in the original geometry.

4. The method of claim 1, wherein the component comprises an airfoil.

5. The method of claim 4, wherein the cooling supply is internal within the airfoil.

6. The method of claim 4, wherein the damaged portion includes at least a portion of a trailing edge of the airfoil.

7. The method of claim 6, wherein the damaged portion includes a portion of a suction side and of a pressure side of the airfoil.

8. The method of claim 6, wherein the component is a turbine blade with the airfoil extending from a platform to a tip.

9. The method of claim 8, wherein the damaged portion includes a portion of the tip of the turbine blade.

10. The method of claim 6, the component is a turbine nozzle segment with the airfoil extending from an inner band to an outer band.

11. The method of claim 1, wherein the repaired portion is applied directly onto the intermediate component through additive manufacturing.

12. The method of claim 1, wherein applying using additive manufacturing a repaired portion onto the intermediate component to form a repaired component comprises:
forming the repaired portion using additive manufacturing; and
thereafter, bonding the repaired portion onto the intermediate component to form the repaired component.

13. The method of claim 1, further comprising:
imaging the intermediate component to create a digital representation of the intermediate component after removal of the damaged portion.

14. The method of claim 1, wherein the film holes of the repaired geometry mitigate heat directed at the component that caused, at least in part, the damaged portion.

15. The method of claim 1, wherein the component comprises a combustion liner.

16. The method of claim 1, wherein the component comprises a first material, and wherein the repaired portion comprises a second material that has a composition that is compatible to the first material.

17. The method of claim 1, wherein the first material and the second material comprise a super-alloy.

18. The method of claim 1, wherein the component comprises a first material, and wherein the repaired portion comprises a second material that has a composition that is different than the first material.
